(19) United States
(12) Patent Application Publication
(10) Pub. No.: US 2019/0350197 A1
(43) Pub. Date: Nov. 21, 2019

(54) Composition comprising polyurethane microcapsules comprising cinmethylin

(71) Applicant: BASF Agro B.V., Amhem (NL)

(72) Inventors: Klaus KOLB, Limburgerhof (DE); Marc NOLTE, Limburgerhof (DE); Wolfgang GREGORI, Limburgerhof (DE); Martina SCHMITT, Limburgerhof (DE); Diana FRANZ, Limburgerhof (DE); Helmut KRAUS, Limburgerhof (DE)

(21) Appl. No.: 16/466,872

(22) PCT Filed: Nov. 29, 2017
(86) PCT No.: PCT/EP2017/080750

§ 371 Date: Jun. 5, 2019

(30) Foreign Application Priority Data
Dec. 7, 2016 (EP) 16202677.7

(51) Int. Cl. A01N 25/28; A01N 43/90; A01N 47/28

(52) U.S. Cl. CPC A01N 25/28; A01N 47/28; A01N 43/90

(57) ABSTRACT

The present invention relates to a composition comprising microcapsules, wherein the micro-capsules comprise a polyurea shell and a core, wherein the core comprises cinmethylin and the shell comprises a polymerization product of a tetramethylxylylene and an aliphatic diamine diisocyanate, and, optionally, a cycloaliphatic diisocyanate; to a method for preparing the composition comprising the steps of contacting water, cinmethylin, the diisocyanate and the aliphatic diamine; and to a method of controlling undesired plant growth and/or for regulating the growth of plants, wherein the composition is allowed to act on the soil and/or on undesired plants and/or on the crop plants and/or on their environment.

The present invention relates to a composition comprising microcapsules, wherein the microcapsules comprise a polyurea shell and a core, wherein the core comprises cinmethylin and the shell comprises a polymerization product of a tetramethylxylylene and an aliphatic diamine diisocyanate, and, optionally, a cycloaliphatic diisocyanate; to a method for preparing the composition comprising the steps of contacting water, cinmethylin, the diisocyanates and the aliphatic diamine; and to a method of controlling undesired plant growth and/or for regulating the growth of plants, wherein the composition is allowed to act on the soil and/or on undesired plants and/or on the crop plants and/or on their environment.

Since the herbicide cinmethylin is an oily liquid, and because of its volatile nature, there is a need for agrochemical formulations, wherein the volatility of cinmethylin is reduced and its release from the formulation is prolonged in order to ensure long-lasting herbicidal effects and to minimize detrimental effects such as phytotoxicity or insufficient compatibility with other agrochemicals and/or pesticides. One way to control the evaporation are compositions, wherein cinmethylin is encapsulated in microcapsules.

Agrochemical microcapsules, which comprise a polyurea shell and a core, which comprises cinmethylin, are known, but still need some improvement. WO 94/13139 A1 discloses microcapsules comprising cinmethylin, whose shell is made of polyurethanes obtained by the reaction of hexamethylenediamine and PAPI® 2027 (a polymethylene polyphenylisocyanate from Dow Chemical).

WO 2015/165834 A1 discloses microcapsules comprising cinmethylin, whose shell is made of polyurethanes obtained by the reaction of Bayhydur® XP 2547 (an anionic water-dispersible poly-isocyanate based on hexamethylene diisocyanate), dicyclohexylmethane diisocyanate and a polyethyleneimine.

The microcapsules described in the prior art do not release sufficient amounts of cinmethylin and in consequence result in unsatisfactory herbicidal efficacy of compositions comprising them. It is therefore an objective of the present invention to provide microcapsule compositions, which control the release of cinmethylin from such microcapsules without compromising the herbicidal efficacy.

The objectives were solved by a composition comprising microcapsules, wherein the microcapsules comprise a polyurea shell and a core, wherein the core comprises cinmethylin and the shell comprises a polymerization product of
a tetramethylxylylene diisocyanate, and
an aliphatic diamine.

In a further aspect the present invention relates to a composition comprising microcapsules, wherein the microcapsules comprise a polyurea shell and a core, wherein the core comprises cinmethylin and the shell comprises a polymerization product of
a tetramethylxylylene diisocyanate,
a cycloaliphatic diisocyanate, and
an aliphatic diamine.

Cinmethylin is a selective, pre-emergence, systemic herbicide useful for the control of annual grass weeds, for example in rice. The common name cinmethylin herein refers to the racemic mixture (±)-2-exo-(2-methylbenzyloxy)-1-methyl-4-isopropyl-7-oxabicyclo[2.2.1]heptane (also referred to as the “exo-(±)-isomers”, CAS RN 87818-31-3)

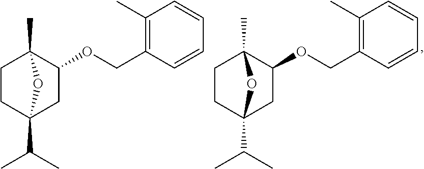

any of its individual enantiomers or any non-racemic mixture thereof. The racemic mixture contains equal parts of the two enantiomers (+)-2-exo-(2-M ethylbenzyloxy)-1-methyl-4-isopropyl-7-oxabicyclo[2.2.1]heptane (also referred to as the “exo-(+)- isomer”, CAS RN 87818-61-9) and (−)-2-exo-(2-Methylbenzyloxy)-1-methyl-4-isopropyl-7-oxabicyclo[2.2.1]heptane (also referred to as the “exo-(−)-isomer”, CAS RN 87819-60-1). The exo-(±)-isomers, the exo-(+)-isomer and the exo-(−)-isomer including their preparation and herbicidal properties are disclosed in EP 0 081 893 A2 (see Examples 29, 34, 35 and 62). Further preparation methods of these compounds are described in U.S. Pat. No. 4,487,945 (see Embodiments 46 and 48). The racemic mixture (±)-2-exo-(2-Methylbenzyloxy)-1-methyl-4-isopropyl-7-oxabicyclo[2.2.1]heptane is also described in The Pesticide Manual, Fourteenth Edition, Editor: C.D.S. Tomlin, British Crop Production Council, 2006, entry 157, pages 195-196 with its IUPAC name (1RS,2SR,4SR)-1,4-epoxy-p-menth-2-yl 2-methylbenzyl ether and its Chemical Abstracts name exo-(±)-1-methyl-4-(1-methylethyl)-2-[(2-methylphenyl)methoxy]-7-oxabicyclo[2.2.1]heptane. Cinmethylin is a liquid, which is barely soluble in water (0.063 g-L⁻¹ at 20° C.), but soluble in organic solvents. it has a boiling point of 312° C. (Pesticide Science, 1987, 21, Nr. 2, 143-153).

A suitable tetramethylxylylene diisocyanate is meta- or para-substituted tetramethylxylylene diisocyanate. Preferably the tetramethylxylylene diisocyanate is the compound of formula (II)

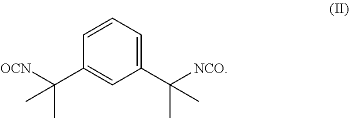

Suitable cycloaliphatic diisocyanates are 1-isocyanato-3,3,5-trimethyl-5-isocyanatomethyl-cyclo-hexane (isophorone diisocyanate, IPDI), 1,4- and/or 1,3-bis(isocyanatomethyl)cyclohexane (HXDI), cyclohexan-1,4-diisocyanate, 1-methyl-2,6-cyclohexane diisocyanate, 1-methyl-2,4-cyclohexane diisocyanate, 2,2′-dicyclohexylmethane diisocyanate, 2,4′-dicyclohexylmethane diisocyanate, or 4,4′-dicyclohexylmethane diisocyanate. Preferably, the cycloaliphatic diisocyanate is 4,4′-dicyclohexylmethane diisocyanate, which corresponds to the compound of formula (I).

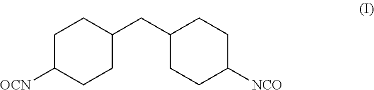

Suitable aliphatic diamines are of the formula H₂N—(CH₂)ₙ—N H₂, wherein n is an integer from 2 to 8 (preferably 4 to 6). Exemplary of such diamines are ethylenediamine, propylene-1,3-diamine, tetramethylenediamine, pentamethylenediamine and hexamethylenediamine. A preferred aliphatic diamine is hexane-1,6-diamine.

In microcapsules comprising tetramethylxylylene diisocyanate the polyurea shell comprises usually at least 35 wt %, preferably at least 45 wt %, and in particular at least 55 wt % of the tetramethylxylylene diisocyanate. The polyurea shell comprises usually 35 to 90 wt %, preferably 45 to 85 wt %, and in particular 55 to 75 wt % of the tetramethylxylylene diisocyanate. The wt % of the diisocyanate in the polyurea shell refers to the total amount of monomers.

In microcapsules comprising tetramethylxylylene diisocyanate and a cycloaliphatic diisocyanate the polyurea shell comprises usually at least 35 wt %, preferably at least 45 wt %, and in particular at least 55 wt % of the tetramethylxylylene diisocyanate. The polyurea shell comprises usually 35 to 85 wt %, preferably 50 to 80 wt %, and in particular 50 to 70 wt % of the tetramethylxylylene diisocyanate. The wt % of the tetramethylxylylene diisocyanate in the polyurea shell refers to the total amount of monomers.

In microcapsules comprising tetramethylxylylene diisocyanate and a cycloaliphatic diisocyanate the polyurea shell comprises usually up to 20 wt %, preferably up to 15 wt %, and in particular up to 12 wt % of the cycloaliphatic diisocyanate (e.g. the compound of the formula (I)). The polyurea shell comprises usually 1 to 20 wt %, preferably 2 to 20 wt %, and in particular 4 to 12 wt % of the cycloaliphatic diisocyanate (e.g. the compound of the formula (I)). The wt % of cycloaliphatic diisocyanate in the polyurea shell refers to the total amount of monomers.

The polyurea shell usually comprises at least 1 wt %, preferably at least 15 wt %, and in particular at least 25 wt % of the alphatic diamine. In another embodiment the polyurea shell comprises usually 1 to 40 wt %, preferably 15 to 35 wt %, and in particular 25 to 35 wt % of the alphatic diamine. The wt % of the alphatic diamine in the polyurea shell refers to the total amount of monomers.

In microcapsules comprising tetramethylxylylene diisocyanate and a cycloaliphatic diisocyanate the polyurea shell comprises usually up to 50 wt %, preferably up to 35 wt %, and in particular up to 30 wt % of the aliphatic diamine (e.g. of the formula H₂N—(CH₂)ₙ—NH₂, wherein n is an integer from 2 to 8). The polyurea shell comprises usually 1 to 50 wt %, 1 to 40 wt %, preferably 15 to 35 wt % and in particular 25 to 35 wt % of the aliphatic diamine (e.g. of the formula H₂N—(CH₂)ₙ—NH₂, wherein n is an integer from 2 to 8). The wt % of aliphatic diamine in the polyurea shell refers to the total amount of monomers.

The polyurea shell may comprise other polyisocyanates, which have at least two isocyanate groups and which are different from the tetramethylxylylene diisocyanate. Usually, the polyurea shell comprises up to 10 wt %, preferably up to 5 wt % of the other polyisocyanates, and in particular it is free of the other polyisocyanates. The wt % of the further polyisocyanates in the polyurea shell refers to the total amount of monomers.

The polyurea shell may comprise further polyisocyanates, which have at least two isocyanate groups and which are different from the tetramethylxylylene diisocyanate and from the cycloaliphatic diisocyanate. Usually, the polyurea shell comprises up to 10 wt %, preferably up to 5 wt %, and in particular up to 1 wt % of the further polyisocyanates. The wt % of the further polyisocyanates in the polyurea shell refers to the total amount of monomers.

The polyurea shell may comprise further polyamines, which have at least two amine groups and which are different from the aliphatic diamine. Usually, the polyurea shell comprises up to 10 wt %, preferably up to 5 wt %, and in particular up to 1 wt % of the further polyamines. The wt % of the further polyamines in the polyurea shell refers to the total amount of monomers.

In one aspect the weight ratio of the tetramethylxylylene diisocyanate to the cycloaliphatic diisocyanate, for example the compound of the formula (I), is at least 4:1, preferably at least 3:1, more preferably at least 5:2, usually in the range from 50:1 to 4:1, from 50:1 to 3:1 or from 50:1 to 5:2, preferably from 30:1 to 4:1, from 30:1 to 3:1 or from 30:1 to 5:2, more preferably from 20:1 to 4:1, from 20:1 to 3:1 or from 20:1 to 5:2, and in particular from 15:1 to 4:1, from 15:1 to 3:1 or from 15:1 to 5:2.

In one aspect the weight ratio of the diisocyanate and, optionally, of the further polyisocyanates to the aliphatic diamine and, optionally, of the further polyamines, is usually in the range from 20:1 to 2:1, preferably from 10:1 to 2:1, more preferably from 5:1 to 2:1, particularly from 4:1 to 3:1.

The weight ratio of the core to the polyurea shell is usually in the range from 99:1 to 70:30, preferably from 98:2 to 80:20, and in particular from 95:5 to 85:15. The weight of the core is based on the amount of cinmethylin and, optionally, the water immiscible organic solvent, and optionally the further solvents. The weight of the polyurea shell is based on the amounts of the tetramethylxylylene diisocyanate, the cycloaliphatic diisocyanate, the aliphatic diamine, and optionally the further polyisocyanates, and the further polyamines.

In one embodiment the polyurea shell comprises 50 to 80 wt % of the tetramethylxylylene diisocyanate, preferably the compound of the formula (II), 1 to 20 wt % of the cycloaliphatic diisocyanate, preferably the compound of the formula (I), 15 to 35 wt % of the aliphatic diamine as defined or preferably defined herein, particularly hexane-1,6-diamine. The wt % of the diisocyanates and of the aliphatic diamine in the polyurea shell refers to the total amount of monomers. In a preferred embodiment the polyurea shell comprises 50 to 80 wt % of the tetramethylxylylene diisocyanate, preferably the compound of the formula (II), 1 to 20 wt % of the cycloaliphatic diisocyanate, preferably the compound of the formula (I), 15 to 35 wt % of the aliphatic diamine as defined or preferably defined herein, particularly hexane-1,6-diamine, and the weight ratio of the tetramethylxylylene diisocyanate to the cycloaliphatic diisocyanate is at least 4:1, preferably at least 3:1, more preferably at least 5:2, or in the range from 50:1 to 4:1, preferably from 50:1 to 3:1, more preferably from 50:1 to 5:2. The wt % of the diisocyanates and of the aliphatic diamine in the polyurea shell refers to the total amount of monomers.

In still another preferred embodiment the polyurea shell comprises 50 to 80 wt % of the tetramethylxylylene diisocyanate, preferably the compound of the formula (II), 1 to 20 wt % of the cycloaliphatic diisocyanate, preferably the compound of the formula (I), 15 to 35 wt % of the aliphatic diamine as defined or preferably defined herein, particularly hexane-1,6-diamine, up to 10 wt % of the further polyisocyanates, up to 10 wt % of the further polyamines, and the weight ratio of the tetramethylxylylene diisocyanate to the cycloaliphatic diisocyanate is at least 4:1, preferably at least 3:1, more preferably at least 5:2, or in the range from 50:1 to 4:1, preferably from 50:1 to 3:1, more preferably from 50:1 to 5:2; and wherein the weight ratio of the diisocyanate and, optionally, the further polyisocyanates to the aliphatic diamine and, optionally, the further polyamines, is in the range from 20:1 to 2:1. The wt % of the diisocyanates and of the aliphatic diamine in the polyurea shell refers to the total amount of monomers.

In another preferred aspect the polyurea shell comprises 50 to 70 wt % of the tetramethylxylylene diisocyanate, preferably the compound of the formula (II), 1 to 20 wt % of the cycloaliphatic diisocyanate, preferably the compound of the formula (I), 25 to 35 wt % of the aliphatic diamine as defined or preferably defined herein, particularly hexane-1,6-diamine. The wt % of the diisocyanates and of the aliphatic diamine in the polyurea shell refers to the total amount of monomers.

In still another preferred embodiment the polyurea shell comprises 50 to 70 wt % of the tetramethylxylylene diisocyanate, preferably the compound of the formula (II), 1 to 20 wt % of the cycloaliphatic diisocyanate, preferably the compound of the formula (I), 25 to 35 wt % of the aliphatic diamine as defined or preferably defined herein, particularly hexane-1,6-diamine, and the weight ratio of the tetramethylxylylene diisocyanate to the cycloaliphatic diisocyanate is at least 4:1, preferably at least 3:1, more preferably at least 5:2, or in the range from 15:1 to 4:1, preferably from 15:1 to 3:1, more preferably from 15:1 to 5:2. The wt % of the diisocyanates and of the aliphatic diamine in the polyurea shell refers to the total amount of monomers.

In a further preferred aspect the polyurea shell comprises 50 to 70 wt % of the tetramethylxylylene diisocyanate, preferably the compound of the formula (II), 1 to 20 wt % of the cycloaliphatic diisocyanate, preferably the compound of the formula (I), 25 to 35 wt % of the aliphatic diamine as defined or preferably defined herein, particularly hexane-1,6-diamine, up to 1 wt % of the further polyisocyanates, up to 1 wt % of the further polyamines, and the weight ratio of the tetramethylxylylene diisocyanate to the cycloaliphatic diisocyanate is at least 4:1, preferably at least 3:1, more preferably at least 5:2, or in the range from 15:1 to 4:1, preferably from 15:1 to 3:1, more preferably from 15:1 to 5:2; and wherein the weight ratio of the diisocyanate and, optionally, the further polyisocyanates to the aliphatic diamine and, optionally, the further polyamines, is in the range from 5:1 to 2:1, particularly from 4:1 to 3:1. The wt % of the diisocyanates and of the aliphatic diamine in the polyurea shell refers to the total amount of monomers.

Microcapsules with a polyurea shell can be prepared in analogy to the prior art. They are preferably prepared by an interfacial polymerization process of a suitable polymer wall forming material, such as a diisocyanate and a diamine. Interfacial polymerization is usually performed in an aqueous oil-in-water emulsion or suspension of the core material containing dissolved therein at least one part of the polymer wall forming material. During the polymerization, the polymer segregates from the core material to the boundary surface between the core material and water thereby forming the wall of the microcapsule. Thereby an aqueous suspension of the microcapsule material is obtainable. Suitable methods for interfacial polymerization processes for preparing microcapsules containing pesticide compounds have been disclosed in the prior art. In general, polyurea is formed by reacting at least one diisocyanate with at least one diamine to form a polyurea shell.

The average size of the microcapsules (z-average by means of light scattering) is characterized by a D₅₀ of 0.5 to 20 μm, more preferably 1 to 15 μm, and especially 2 to 10 μm; in a preferred embodiment the average size is characterized by a D_{50 of} 0.5 to 20 μm and a D₉₀ of 5 to 30 μm, more preferably a D₅₀ of 1 to 15 μm and a D₉₀ of 5 to 20 μm; most preferably a D₅₀ of 2 to10 μm and a D₉₀ of 8 to 15 μm.

In one embodiment the core of the microcapsules comprises a water immiscible organic solvent. Suitable examples for water immiscible organic solvents are
a hydrocarbon solvent such as aliphatic, cyclic and aromatic hydrocarbons (e. g. toluene, xylene, paraffin, tetrahydronaphthalene, alkylated naphthalenes or their derivatives, mineral oil fractions of medium to high boiling point (such as kerosene, diesel oil, coal tar oils));
a vegetable oil such as corn oil, rapeseed oil;
a fatty acid ester such as C₁-C₁₀-alkylester of a C₁₀-C₂₂-fatty acid; or
methyl- or ethyl esters of vegetable oils such as rapeseed oil methyl ester or corn oil methyl ester
partly saponified fats and oils
rosins and rosin oils.

Mixtures of aforementioned water immiscible organic solvents are also possible. The water immiscible organic solvent is usually commerically available, such as the hydrocarbons under the tradenames Solvesso® 200, Aromatic® 200, or Caromax® 28. The aromatic hydrocarbons may be used as naphthalene depleted qualities. Preferred water immiscible organic solvents are hydrocarbons, in particular aromatic hydrocarbons.

Preferably, the water immiscible organic solvent has a solubility in water of up to 20 g/L at 20° C., more preferably of up to 5 g/L and in particular of up to 0.5 g/L.

Usually, the water immiscible organic solvent has a boiling point above 100° C., preferably above 150° C., and in particular above 180° C.

In a preferred form the core of the microcapsule comprises up to 10 wt %, preferably up to 5 wt %, and in particular up to 1 wt % of the water immiscible organic solvent.

In one aspect of the invention the core of the microcapsules comprises further solvents, e.g. up to 30 wt %, preferably up to 15 wt %, based on the total amount of all solvents in the core.

In one embodiment the core of the microcapsule comprises at least 90 wt %, preferably at least 95 wt %, and in particular at least 99 wt % of cinmethylin, optionally the water-immiscible organic solvent, and optionally the further solvent. In another form the core of the microcapsule consists of cinmethylin, optionally the water-immiscible organic solvent, and optionally the further solvent.

In one embodiment the composition is an aqueous composition, which comprises an aqueous phase (e.g. a continuous aqueous phase). The aqueous composition may comprise at least 10 wt %, preferably at least 25 wt %, and in particular at least 35 wt % water. Usually, the microcapsules are suspended in the aqueous phase of the aqueous compositon.

Preferably, the composition is an aqueous composition and the aqueous phase comprises a lignosulfonate. Lignosulfonates which are suitable are the alkali metal salts and/or alkaline earth metal salts and/or ammonium salts, for example the ammonium, sodium, potassium, calcium or magnesium salts of lignosulfonic acid. The sodium, potassium and/or calcium salts are very particularly preferably used. Naturally, the term lignosulfonates also encompasses mixed salts of different ions, such as potassium/sodium lignosulfonate, potassium/calcium lignosulfonate and the like, in particular sodium/calcium lignosulfonate.

In one aspect the lignosulfonate is based on kraft lignins. Kraft lignins are obtained in a pulping process of lignins with sodium hydroxide and sodium sulfide. The kraft lignins are sulfonated to obtain the lignosulfonate.

The molecular mass of the lignosulfonate may vary from 500 to 20000 g/mol. Preferably, the lignosulfonate has a molecular weight of 700 to 10000 g/mol, more preferably from 900 to 7000 g/mol, and in particular from 1000 to 5000 g/mol.

The lignosulfonate is usually soluble in water (e.g. at 20° C.), e.g. at least 5 wt %, preferably at least 10 wt %, and in particular at least 20 wt %.

The aqueous composition comprises usually 0.1 to 5.0 wt %, preferably 0.3 to 3.0 wt %, and in particular 0.5 to 2.0 wt % of the lignosulfonate.

The core usually comprises cinmethylin in liquid form (e.g. when the core is free of the water immiscible organic solvent; or when the core consists of cinmethylin), or dissolved in the water-immiscible organic solvent. Preferably, the core comprises cinmethylin in liquid form (e.g. when the core is free of the water immiscible organic solvent; or when the core consists of cinmethylin).

The composition (e.g. the aqueous composition) contains usually at least 1 wt % encapsulated pesticide, preferably at least 3 wt % and in particular at least 10 wt %.

The composition may also contain a water-soluble inorganic salt, which may result from the preparation of the microcapsules or which may be added thereafter. If present, the concentration of the water-soluble, inorganic salt may vary from 1 to 200 g/L, preferably from 2 to 150 g/L and especially from 10 to 130 g/L. Water-solubility of the salt means solubility in water of at least 50 g/L, in particular at least 100 g/L or even at least 200 g/L at 20° C.

Such inorganic salts are preferably selected from sulfates, chlorides, nitrates, mono and dihydrogen phosphates of alkali metals, the sulfates, chlorides, nitrates, mono and dihydrogen phosphates of ammonia, chlorides and nitrates of alkaline earth metals and magnesium sulfate. Examples include lithium chloride, sodium chloride, potassium chloride, lithium nitrate, sodium nitrate, potassium nitrate, lithium sulfate, sodium sulfate, potassium sulfate, sodium monohydrogen phosphate, potassium monohydrogen phosphate, sodium dihydrogen phosphate, potassium dihydrogen phosphate, magnesium chloride, calcium chloride, magnesium nitrate, calcium nitrate, magnesium sulfate, ammonium chloride, ammonium sulfate, ammonium monohydrogen phosphate, ammonium dihydrogen phosphate and the like. Preferred inorganic salts are sodium chloride, potassium chloride, calcium chloride, ammonium sulfate and magnesium sulfate with ammonium sulfate and magnesium sulfate being especially preferred.

In another embodiment, the composition does not contain or contains less than 10 g/L in particular less than 1 g/L of the water-soluble inorganic salt.

The composition may comprise a glycol, such as ethylene glycol, propylene glycol. The composition may comprise from 1 to 250 g/L, preferably from 10 to 150 g/L and especially from 30 to 100 g/L of the glycol.

The composition may comprise further auxiliaries outside the microcapsules, e.g. in the aqueous phase of the aqueous composition. Examples for suitable auxiliaries are surfactants, dispersants, emulsifiers, wetters, adjuvants, solubilizers, penetration enhancers, protective colloids, adhesion agents, thickeners, humectants, repellents, attractants, feeding stimulants, compatibilizers, bactericides, anti-foaming agents, antifreeze agents, colorants, tackifiers and binders.

Suitable surfactants are surface-active compounds, such as anionic, cationic, nonionic and amphoteric surfactants, block polymers, polyelectrolytes, and mixtures thereof. Such surfactants can be used as emusifier, dispersant, solubilizer, wetter, penetration enhancer, protective colloid, or adjuvant. Examples of surfactants are listed in McCutcheon's, Vol.1: Emulsifiers & Detergents, McCutcheon's Directories, Glen Rock, USA, 2008 (International Ed. or North American Ed.)

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates. The term sulfonates refers to compounds which are different from the ligninsulfonates.

Suitable nonionic surfactants are alkoxylates, N-subsituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-subsititued fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are home- or copolymers of vinylpyrrolidone, vinylalcohols, or vinylacetate.

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide. Suitable polyelectrolytes are polyacids or polybases. Examples of polyacids are alkali salts of polyacrylic acid or polyacid comb polymers. Examples of polybases are polyvinylamines or polyethyleneamines.

Suitable adjuvants are compounds, which have a negligible or even no pesticidal activity themselves, and which improve the biological performance of cinmethylin on the target. Examples are surfactants, mineral or vegetable oils, and other auxilaries. Further examples are listed by Knowles, Adjuvants and additives, Agrow Reports DS256, T&F Informa UK, 2006, chapter 5.

Suitable thickeners are polysaccharides (e.g. xanthan gum, carboxymethylcellulose), inorganic clays (organically modified or unmodified), polycarboxylates, and silicates.

Suitable bactericides are bronopol and isothiazolinone derivatives such as alkylisothiazolinones and benzisothiazolinones.

Suitable anti-foaming agents (defoamer) are silicones, long chain alcohols, and salts of fatty acids.

Suitable antifreeze agents are urea, ethylene glycol, propylene glycol, glycerol or potassium formate.

The present invention also relates to a method for preparing the composition comprising the steps of contacting water, cinmethylin, the tetramethylxylylene diisocyanate, the aliphatic diamine, and, optionally, the cycloaliphatic diisocyanate. The contacting may be done by mixing the components, e.g. at temperatures from 20 to 100° C.

In one embodiment the method for preparing the composition comprises the steps of contacting an aqueous phase, which comprises at least one dispersant, with an oil phase comprising cinmethylin, the tetramethylxylylene diisocyanate and, optionally, the cycloaliphatic diisocyanate; the mixture is then emulsified using high-shear equipment; to the resulting emulsion the aliphatic diamine is added while stirring is continued with a low shear stirrer. The emulsification and subsequent stirring may be done at temperatures from 20 to 80° C.

The particle size distribution resulting from high-shear stirring is typically characterized by the following parameters: a D₅₀ of 0.5 to 20 μm and a D₉₀ of 5 to 30 μm, more preferably a D₅₀ of 1 to 15 μm and a D₉₀ of 5 to 20 μm; most preferably a D₅₀ of 2 to10 μm and a D₉₀ of 8 to 15 μm (z-average by means of light scattering).

In a preferred embodiment of the invention the composition is prepared as follows:

Step 1) an oil phase comprising cinmethylin, tetramethylxylylene diisocyanate and, optionally, the cyclic diisocyanate, is added to an aqueous phase at temperatures from 20 to 80° C.; this aqueous phase comprises at least one dispersant; for example, the dispersant may be selected from the group consisting of lignosulfonates, condensed alkyl naphthalene sulfonates or condensed phenol sulphonates, as defined herein; the mixture is then emulsified using high-shear equipment, so that the resulting particle size distribution in the emulsion is characterized by a D₅₀ of 2 to10 μm and a D₉₀ of 8 to 15 μm (z-average by means of light scattering). Optionally, the aqueous phase additionally comprises a water-soluble inorganic salt as defined herein below, whereas said salt is preferably selected from sodium chloride, potassium chloride, calcium chloride, ammonium sulfate and magnesium sulfate; and/or an anti-freeze agent, whereas the anti-freeze agent is preferably selected from ethylene and propylene glycol; and/or an anti-foaming agent, for example a silicone defoamer.

Step 2) after emulsification, the emulsification device is replaced by a low shear stirrer and the aliphatic diamine is added, preferably as an aqueous solution (5 to 50% by weight, preferably 15 to 35% by weight based on the aqueous solution added). Subsequently, the dispersion is smoothly agitated at 20 to 80° C., preferably for 30 minutes to 150 minutes, more preferably for 60 to 120 minutes.

Optionally, in a third step, the capsule dispersion is treated under stirring with an aqueous finish solution comprising, for example, a dispersant system, an anti-freeze agent, a thickener, a defoamer, or a biocide, or a combination thereof; the pH may be adjusted to pH 6 to 8 by addition of an inorganic or organic acid, for example acetic acid.

The concentration of the water-soluble, inorganic salt in the aqueous phase in step 1) may vary from 2 to 150 g/L, preferably from 10 to 130 g/L and especially from 50 to 100 g/L. Water-solubility of the salt means solubility in water of at least 50 g/L, in particular at least 100 g/L or even at least 200 g/L at 20° C.

Such inorganic salts are preferably selected from sulfates, chlorides, nitrates, mono and dihydrogen phosphates of alkali metals, the sulfates, chlorides, nitrates, mono and dihydrogen phosphates of ammonia, chlorides and nitrates of alkaline earth metals and magnesium sulfate. Examples include lithium chloride, sodium chloride, potassium chloride, lithium nitrate, sodium nitrate, potassium nitrate, lithium sulfate, sodium sulfate, potassium sulfate, sodium monohydrogen phosphate, potassium monohydrogen phosphate, sodium dihydrogen phosphate, potassium dihydrogen phosphate, magnesium chloride, calcium chloride, magnesium nitrate, calcium nitrate, magnesium sulfate, ammonium chloride, ammonium sulfate, ammonium monohydrogen phosphate, ammonium dihydrogen phosphate and the like. Preferred inorganic salts are sodium chloride, potassium chloride, calcium chloride, ammonium sulfate and magnesium sulfate with ammonium sulfate and magnesium sulfate being especially preferred.

The present invention furthermore relates to a method of controlling phytopathogenic fungi and/or undesired plant growth and/or undesired insect or mite attack and/or for regulating the growth of plants, wherein the composition according to the invention is allowed to act on the respective pests, their environment or the crop plants to be protected from the respective pest, on the soil and/or on undesired plants and/or on the crop plants and/or on their environment.

Examples of suitable crop plants are cereals, for example wheat, rye, barley, triticale, oats or rice; beet, for example sugar or fodder beet; pome fruit, stone fruit and soft fruit, for example appies, pears, plums, peaches, almonds, cherries, strawberries, raspberries, currants or gooseberries; legumes, for example beans, lentils, peas, lucerne or soybeans; oil crops, for example oilseed rape, mustard, olives, sunflowers, coconut, cacao, castor beans, oil palm, peanuts or soybeans; cucurbits, for example pumpkins/squash, cucumbers or melons; fiber crops, for example cotton, flax, hemp or jute; citrus fruit, for example oranges, lemons, grapefruit or tangerines; vegetable plants, for example spinach, lettuce, asparagus, cabbages, carrots, onions, tomatoes, potatoes, pumpkin/squash or capsicums; plants of the laurel family, for example avocados, cinnamon or camphor; energy crops and industrial feedstock crops, for example maize, soybeans, wheat, oilseed rape, sugar cane or oil palm; maize; tobacco; nuts; coffee; tea; bananas; wine (dessert grapes and grapes for vinification); hops; grass, for example turf; sweetleaf (Stevia rebaudania); rubber plants and forest plants, for example flowers, shrubs, deciduous trees and coniferous trees, and propagation material, for example seeds, and harvested produce of these plants.

The term crop plants also includes those plants which have been modified by breeding, mutagenesis or recombinant methods, including the biotechnological agricultural products which are on the market or in the process of being developed. Genetically modified plants are plants whose genetic material has been modified in a manner which does not occur under natural conditions by hybridizing, mutations or natural recombination (i.e. recombination of the genetic material). Here, one or more genes will, as a rule, be integrated into the genetic material of the plant in order to improve the plant's properties. Such recombinant modifications also comprise posttranslational modifications of proteins, oligo- or polypeptides, for example by means of glycosylation or binding polymers such as, for example, prenylated, acetylated or farnesylated residues or PEG residues.

The user applies the composition according to the invention usually from a predosage device, a knapsack sprayer, a spray tank, a spray plane, or an irrigation system. Usually, the agrochemical composition is made up with water, buffer, and/or further auxiliaries to the desired application concentration and the ready-to-use spray liquor or the agrochemical composition according to the invention is thus obtained. Usually, 20 to 2000 liters, preferably 50 to 400 liters, of the ready-to-use spray liquor are applied per hectare of agricultural useful area.

Various types of oils, wetters, adjuvants, fertilizer, or micronutrients may be added to the agro-chemical compositions comprising them as premix or, if appropriate not until immediately prior to use (tank mix). These agents can be admixed with the compositions according to the invention in a weight ratio of 1:100 to 100:1, preferably 1:10 to 10:1.

When employed in plant protection, the amounts of cinmethylin applied are, depending on the kind of effect desired, from 0.001 to 2 kg per ha, preferably from 0.005 to 2 kg per ha, more preferably from 0.05 to 0.9 kg per ha, in particular from 0.05 to 0.6 kg per ha.

The present invention has various advantages: The composition has advantageous rheological properties and thus has a favourable flow behavior (typically compositions with a viscosity in the range from 80 to 400 mPas at 100 s⁻¹, measured according to the method described herein, provide acceptable flow behavior in agrochemical formulations, for example pourability or rinsability; these properties are relevant criteria in the registration of agrochemical formulations); the composition is stable during storage for a long time, for example even at a wide temperature range; the composition can be applied after dilution with water without clogging the spray nozzles; the composition is stable after dilution with water; the composition may be mixed with various other crop protection products and provides better compatibility of the active components (e.g. reduced sedimentation, flocculation, crystallization) when compared with mixtures comprising non-encapsulated cinmethylin; the volatility of cinmethylin is reduced; the UV sensitivity is reduced; cinmethylin is more stable after application to the crop; the toxicity of the monomers used to prepare the polyurea shell is reduced as compared to monomers that are used in microcapsules known from the prior art; the composition provides better mobility of cinmethylin into soil.

### EXAMPLES

The examples below give further illustration of the invention, which is not, however, restricted to these examples.
TMXDI: tetramethyl-m-xylylene diisocyanate, CAS 2778-42-9
Cyclic diisocyanate: bis(4-isocyanotocyclohexyl) methane (compound of formula (I))
Lignosulfonate: sodium salt of lignosulfonate, based on Kraft lignin, molecular weight about 3000 g/mol, water-soluble, CAS 68512-34-5
Additive A: sodium salt of naphthalene sulfonate condensate
Additive B: hydrophobically modified polyacrylate, anionic polymeric dispersant, powder, molecular weight 1-20 kDa, pH 7-8.5 (1 wt % in water)
Additive C: Poly[(2-ethyldimethylammonioethyl methacrylate ethyl sulfate)-co-(1-vinylpyrrolidone)], commercially available as Polyquaternium D11
Additive D: Polyvinylalcohol, commercially available as Koraray Poval 25-88 KL
Biocide: water based formulation of 2-methyl-4-isothiazolin-3-one and 1,2-benzisothiazolin-3-one

Experiments 1-6

### Preparation of Cinmethylin Microcapsules

The oil phase comprising cinmethylin, TMXDI and the cyclic diisocyanate was added at 65° C. to the water phase, which comprised Lignosulfonate, and emulsified using high-shear equipment. After emulsification, the emulsification device was replaced by a low shear stirrer and the hexa-methylene diamine was added. Subsequently, the dispersion was smoothly agitated for 30-60 minutes at 60° C. Under stirring the aqueous finish solution comprising Additives A and B, 1,2-propylene glycol, xanthan gum, a silicon defoamer, and a biocide was added to the capsule dispersion and the pH adjusted to pH 6-8 by addition of acetic acid. All experiments resulted in discrete microcapsule suspensions with a capsule diameter of 1-30 μm (D₅₀).

TABLE 1

| | Experiment 1 | Experiment 2 | Experiment 3 |
|---|---|---|---|
| | Amount [g/L] | Amount [g/L] | Amount [g/L] |
| Cinmethylin | 480 | 480 | 480 |
| TMXDI | 15.5 | 15.1 | 14.2 |
| Cyclic diisocyanate | 1.2 | 1.7 | 2.6 |
| Hexane-1,6-diamine | 6.6 | 6.6 | 6.6 |
| Lignosulfonate | 12.0 | 12.0 | 12.0 |
| Additive A | 15.0 | 15.0 | 15.0 |
| Additive B | 15.0 | 15.0 | 15.0 |
| 1,2-Propylene glycol | 15.0 | 50.0 | 15.0 |
| Xanthan gum | 0.45 | 0.45 | 0.45 |
| Silicone defoamer | 1.0 | 1.0 | 1.0 |
| Biocide | 2.0 | 2.0 | 2.0 |
| Water | Ad 1.0 L | Ad 1.0 L | Ad 1.0 L |
| | Experiment 4 | Experiment 5 | Experiment 6 |
| | Amount [g/L] | Amount [g/L] | Amount [g/L] |
| Cinmethylin | 480 | 400 | 400 |
| TMXDI | 11.2 | 14.9 | 15.1 |
| Cyclic diisocyanate | 5.6 | 0 | 1.7 |
| Hexane-1,6-diamine | 6.6 | 5.9 | 6.6 |
| Lignosulfonate | 12.0 | 12.0 | 12.0 |
| Additive A | 15.0 | 15.0 | 15.0 |
| Additive B | 15.0 | 15.0 | 15.0 |
| 1,2-Propylene glycol | 50.0 | 50.0 | 50.0 |
| Xanthan gum | 0.45 | 0.45 | 0.45 |
| Silicone defoamer | 1.0 | 1.0 | 1.0 |
| Biocide | 2.0 | 2.0 | 2.0 |
| Water | Ad 1.0 L | Ad 1.0 L | Ad 1.0 L |

### Experiment 7

### Measurement of Viscosity

The viscosity of the aqueous microcapsule dispersions obtained in Experiments 1-4 were determined by rotational viscometry (Table 2). The method allows for the characterization of the flow behavior of liquid crop protection formulations. A rotational viscometer may be used to characterize both Newtonian and non-Newtonian liquids with a ±1% accuracy with a CV of <0.5%. A sample was transferred to a standard rheometer (TA AR 2000) consisting of a cone and a plate (angle 1°, diameter 60 mm). After calibration, the measurement was carried out under different shear conditions and the apparent viscosities were determined. The apparent viscosity is determined in mPa·s and is defined as the ratio of the shear stress (τ in mPa) divided by the shear rate (γ in s⁻¹).

η=γ(mPa·s)

During the test the temperature of the liquid was kept constant at 20° C. The shear rate was brought to 100 s⁻¹ in one minute. Then 10 measurements were made at 100 s⁻¹ over 10 seconds. The 10th measurement of the 10 second interval at a shear rate of 100 s⁻¹ was declared apparent viscosity.

TABLE 2

| | Weight ratio | Viscosity η at 100 s⁻¹ |
|---|---|---|
| | TMXDI:Cyclic diisocyanate | [mPas] |
| Experiment 1 | 13:1 | 183 |
| Experiment 2 | 9:1 | 150 |
| Experiment 3 | 5.5:1 | 92 |
| Experiment 4 | 2:1 | 668 |

For agrochemical formulations a viscosity in the range from 80 to 400 mPas at 100 s¹⁻ is acceptable. The results demonstrate that the composition of Experiment 4 has a viscosity, which is clearly outside this range.

### Experiments 8-10

### Comparative Examples

In accordance with the preparative instructions given in WO 94/13139 A1 two microcapsule suspension compositions (experiments 8 and 9 in table 3) were prepared, which represent capsules obtained in example 6 of WO 94/13139 A1. Since the emulsifier Agrimer DA-10 was no longer commercially available at the time the experiments were conducted, it was replaced by Additive C, a copolymer which is chemically and physically very similar.

Experiment 10 reproduced microcapsules following the procedure described in WO 2015/165834 A1, example 8.

Experiments 8-10 resulted in discrete microcapsule suspension with a diameter of 1-30 μm (D₅₀) as described in the prior art.

TABLE 3

| | Experiment 8* | Experiment 9* | Experiment 10** |
|---|---|---|---|
| | Amount [g/L] | Amount [g/L] | Amount [g/L] |
| Cinmethylin | 535 | 535 | 427.68 |
| Methylenediphenyldiisocyanate | 37.23 | 37.23 | |
| Hexamethylene diisocyanate, | | | 15.34 |
| Bayhydur ® XP 2547 | | | |
| Dicyclohexylmethane diisocyanat, | | | 54.54 |
| Desmodur ® | | | |
| Additive C | 10.71 | 5.36 | |
| Additive D | | | 34.99 |
| Polyethyleneimine | | | 27.97 |
| Hexane-1,6-diamine | 16.12 | 16.12 | |
| Water | Ad 1.0 L | Ad 1.0 L | Ad 1.0 L |

*Comparative example according to WO 94/13139 A1
**Comparative example according to WO 2015/165834 A1

Herbicidal Efficacy

The effects on the growth of undesirable plants of the herbicidal compositions comprising microcapsules, which were obtained in experiments 5, 6, 8, 9 and 10, was demonstrated by the following greenhouse experiments:

The test plants were seeded in plastic containers in sandy loamy soil containing 5% of organic matter. For the pre-emergence treatment, the compositions were applied directly after sowing by means of finely distributing nozzles at a use rate of 500 g active ingredient/ha. The containers were irrigated gently to promote germination and growth and subsequently covered with transparent plastic hoods until the plants had rooted. This cover caused uniform germination of the test plants unless this was adversely affected by the active compounds. The plants were cultivated according to their individual requirements at 10-25° C. and 20-35° C.

In the following experiments, the herbicidal activity for the individual herbicidal compositions was assessed 20 days after treatment. The results are summarized in table 4. The evaluation for the damage on undesired weeds caused by the compositions was carried out using a scale from 0 to 100%, compared to the untreated control plants. Here, 0 means no damage and 100 means complete destruction of the plants.

The plants used in the greenhouse experiments belonged to the following species:

| EPPO Code | Scientific name |
|---|---|
| ALOMY | Alopecurus myosuroides |
| LOLRI | Lolium rigidum |
| BROST | Bromus sterilis |
| MATIN | Tripleurospermum inodorum |
| PAPRH | Papaver thoeas |
| GALAP | Galium aparine |

TABLE 4

| Formulation | ALOMY | LOLRI | BROST | MATIN | PAPRH | GALAP |
|---|---|---|---|---|---|---|
| EC | 100 | 100 | 98 | 85 | 90 | 85 |
| formulation | | | | | | |
| of | | | | | | |
| Cinmethylin | | | | | | |
| Experiment 5 | 100 | 100 | 100 | 65 | 95 | 60 |
| Experiment 6 | 98 | 80 | 85 | 65 | 95 | 10 |
| Experiment | 30 | 0 | 0 | 50 | 0 | 45 |
| 8* | | | | | | |
| Experiment | 15 | 15 | 0 | 40 | 0 | 40 |
| 9* | | | | | | |
| Experiment | 30 | 0 | 0 | 50 | 0 | 45 |
| 10** | | | | | | |

*Comparative example according to WO 94/13139 A1
**Comparative example according to WO 2015/165834 A1

The herbicidal activity of the microcapsule suspensions of the prior art was low compared to the capsules according to the present invention. The results demonstrate, that the capsules according to the present invention have a similar weed activity as a typical EC type formulation and a better efficacy than microcapsule compositions of the prior art.

Release Test

The amount of released active ingredient over time was determined as followed:

First a 10% solution of Poloxamer 335 (Pluronic PE 10500, EO/PO block-copolymer) was prepared, which was adjusted to pH 5 with acetic acid. This solution acted as receiver solution for the non-encapsulated active or the released active. To 250 mL of the receiver solution 125 mg of the microcapsule suspension was added. The solution was stirred and at defined time points, a sample was drawn. A 0.2 μm Teflon filter was used to remove the remaining microcapsules.

In the filtrate, the pesticide was determined via reverse phase HPLC and normalized in a way that the entire amount of the Pesticide would account for 100%. This would have been found for example if no encapsulation would have taken place (like in an EC formulation) or all of the pesticide would have been released. The release rates are summarized in table 5. The results demonstrate that the microcapsule compositions according to the present invention controlled the release rate of cinmethylin so that a rapid loss of the active ingredient due to its volatility was prevented.

TABLE 5

| | 10 min | 5 h | 24 h | 3 d | 7 d |
|---|---|---|---|---|---|
| Experiment 5 | 50 | 56 | 56 | 57 | 57 |
| Experiment 6 | 53 | 55 | 55 | 55 | 55 |
| Experiment 8* | 0 | 0 | 1 | 6 | 19 |
| Experiment 9* | 0 | 2 | 9 | 20 | 48 |
| Experiment 10** | 0 | 0 | 1 | 2 | 4 |

*Comparative example according to WO 94/13139 A1
**Comparative example according to WO 2015/165834 A1

1-13. (canceled)

14. A composition comprising microcapsules, wherein the microcapsules comprise a polyurea shell and a core, wherein the core comprises cinmethylin and the shell comprises a polymerization product of
a tetramethylxylylene diisocyanate, and
an aliphatic diamine.

15. A composition of claim 14, wherein the shell comprises a polymerization product of
a tetramethylxylylene diisocyanate,
a cycloaliphatic diisocyanate, and
an aliphatic diamine.

16. The composition of claim 14, wherein the tetramethylxylylene diisocyanate is the compound of formula (II)

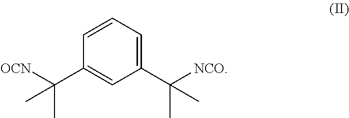

17. The composition of claim 14, wherein the aliphatic diamine is of the formula H₂N—(CH₂)ₙ—NH₂, wherein n is an integer from 2 to 8.

18. The composition of claim 14, wherein the aliphatic diamine is hexane-1,6-diamine.

19. The composition of claim 15, wherein the cycloaliphatic diisocyanate is the compound of formula (I)

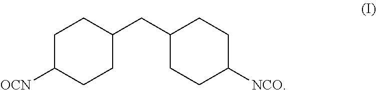

20. The composition of claim 15, wherein the weight ratio of the tetramethylxylylene diisocyanate to the cycloaliphatic diisocyanate is at least 5:2.

21. The composition of claim 15, wherein the polyurea shell comprises 50 to 80 wt % of the tetramethylxylylene diisocyanate, 1 to 20 wt % of the cycloaliphatic diisocyanate, 15 to 35 wt % of the aliphatic diamine and the weight ratio of the tetramethylxylylene diisocyanate to the cycloaliphatic diisocyanate is at least 5:2.

22. The composition of claim 14, wherein the polyurea shell comprises up to 10 wt % of further polyisocyanates, which have at least two isocyanate groups and which are different from the tetramethylxylylene diisocyanate and from the cycloaliphatic diisocyanate.

23. The composition of claim 14 wherein the polyurea shell comprises up to 10 wt % of further polyamines, which have at least two amine groups and which are different from the aliphatic diamine.

24. The composition of claim 14, wherein the weight ratio of the diisocyanate and, optionally, of the further polyisocyanates to the aliphatic diamine and, optionally, of the further polyamines, is in the range from 20:1 to 2:1.

25. A method for preparing the composition as defined in claim 14 comprising the steps of contacting water, cinmethylin, the tetramethylxylylene diisocyanate, the aliphatic diamine and, optionally, the cycloaliphatic diisocyanate.

26. A method of controlling undesired plant growth and/or for regulating the growth of plants, wherein the composition as defined in claim 14 is allowed to act on the soil and/or on undesired plants and/or on the crop plants and/or on their environment.

27. A method of claim 26, wherein the shell comprises a polymerization product of
a tetramethylxylylene diisocyanate,
a cycloaliphatic diisocyanate, and
an aliphatic diamine.

28. The method of claim 26, wherein the tetramethylxylylene diisocyanate is the compound of formula (II)

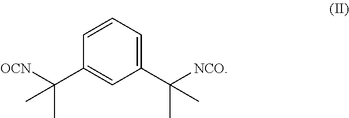

29. The method of claim 26, wherein the aliphatic diamine is of the formula H₂N—(CH₂)ₙ—NH₂, wherein n is an integer from 2 to 8.

30. The method of claim 26, wherein the aliphatic diamine is hexane-1,6-diamine.

31. The method of claim 30, wherein the cycloaliphatic diisocyanate is the compound of formula (I)

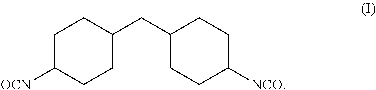

32. The method of claim 30, wherein the weight ratio of the tetramethylxylylene diisocyanate to the cycloaliphatic diisocyanate is at least 5:2.

33. The method of claim 30, wherein the polyurea shell comprises 50 to 80 wt % of the tetramethylxylylene diisocyanate, 1 to 20 wt % of the cycloaliphatic diisocyanate, 15 to 35 wt % of the aliphatic diamine and the weight ratio of the tetramethylxylylene diisocyanate to the cycloaliphatic diisocyanate is at least 5:2.

34. The method of claim 26, wherein the polyurea shell comprises up to 10 wt % of further polyisocyanates, which have at least two isocyanate groups and which are different from the tetramethylxylylene diisocyanate and from the cycloaliphatic diisocyanate.

35. The method of claim 26, wherein the polyurea shell comprises up to 10 wt % of further polyamines, which have at least two amine groups and which are different from the aliphatic diamine.

36. The method of claim 26, wherein the weight ratio of the diisocyanate and, optionally, of the further polyisocyanates to the aliphatic diamine and, optionally, of the further polyamines, is in the range from 20:1 to 2:1.
